(19) United States
(12) Patent Application Publication
(10) Pub. No.: US 2018/0146016 A1
(43) Pub. Date: May 24, 2018

(54) SYSTEM AND METHOD FOR SWITCHING CONTROL WITH BROWSER-BASED SCREEN SHARING

(71) Applicant: CLEARSLIDE INC., San Francisco, CA (US)

(72) Inventor: ADAM MICHAEL LIEB, SAN FRANCISCO, CA (US)

(21) Appl. No.: 15/876,329

(22) Filed: Jan. 22, 2018

Related U.S. Application Data
(63) Continuation of application No. 13/841,237, filed on Mar. 15, 2013.
(60) Provisional application No. 61/665,143, filed on Jun. 27, 2012.

(51) Int. Cl. H04L 29/06

(52) U.S. Cl. CPC H04L 65/403

(57) ABSTRACT

Techniques are disclosed for switching control with browser-based screen sharing. An exemplary method comprises sending a first presentation viewing webpage to a web browser of a viewer, the first presentation viewing webpage including a first view area that allows the server to display screen images of a presenter from the presenter, through the server, to the viewer; delivering to the viewer, in the first presentation viewing webpage, a button selectable for the viewer to share screen images of the viewer to the presenter; upon the viewer selects the button, selectively enabling the viewer to share the viewer's screen images with the presenter; and causing a second presentation vowing webpage to load into a browser of the presenter, wherein the second presentation viewing webpage includes a second view area that allows the server to display the viewer's screen images.

### CROSS-REFERENCE TO RELATED APPLICATIONS

This application claims the benefit of priority as continuation of U.S. patent application Ser. No. 13/841,237 entitled “SYSTEM AND METHOD FOR SWITCHING CONTROL WITH BROWSER-BASED SCREEN SHARING” filed Mar. 15, 2013, currently pending, which itself claims priority from U.S. Provisional Application No. 61/665,143 entitled “SYSTEM AND METHOD FOR SWITCHING CONTROL WITH BROWSER-BASED SCREEN SHARING”, filed Jun. 27, 2012, the entire contents of both being incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the United States Patent and Trademark Office patent files or records, but otherwise reserves all copyright rights whatsoever. The following notice applies to the software and data as described below and in the drawings, that form a part of this document: Copyright 2013, ClearSlide, Inc., All Rights Reserved.

### TECHNICAL FIELD

The present disclosure relates to remote computer screen control, and more specifically, to switching control among a presenter and one or more viewers over a communications network (e.g., the Internet), where a presenter and the viewers use browser-based screen sharing.

### BACKGROUND

Often it is useful for a presenter to broadcast the contents of his computer screen over a network to remote viewers, such as to demonstrate the capabilities of a software product or website. During a screen sharing session, it is Often useful to allow viewers to control the mouse and keyboard, so that the presenter and viewers can, for example, interactively fill out a form together, or the presenter and viewers can collaborate on editing a document, or the presenter can walk the viewers through a training session where the presenter coaches the viewers on how to complete a certain task.

Existing solutions which provide this type of functionality have several limitations. The presenter must normally download and install software (such as executables or plugins) to his computer in order to share the screen and allow remote viewers to control the screen. The viewers must also complete a time-consuming setup process, which can include software downloads and an email-based invitation setup process to connect the viewer to the presenter. These limitations prevent the use of these solutions in certain situations, such as a sales call.

### SUMMARY OF THE DESCRIPTION

In a first aspect, a method for switching control with browser-based screen sharing is disclosed. The method includes sending a first presentation viewing webpage to a web browser of a viewer. The first presentation viewing webpage includes a first view area that allows the server to display screen images of a presenter from the presenter, through the server, to the viewer. The method further includes delivering to the viewer, in the first presentation viewing webpage, a button selectable for the viewer to share screen images of the viewer to the presenter. The method further includes, upon the viewer selects the button, selectively enabling the viewer to share the viewer's screen images with the presenter. The method further includes causing a second presentation viewing webpage to load into a browser of the presenter. The second presentation viewing webpage includes a second ‘view area that allows the server to display the viewer's screen images.

In another aspect, a method includes delivering to the viewer, in a first presentation viewing webpage, a first button selectable for the viewer to initiate the sharing of the viewer's screen images with a presenter. The first presentation viewing webpage is loaded into a web browser of the viewer and includes a first view area that allows a server to display screen images of the presenter from the presenter, through the server, to the viewer. The method further includes, upon the viewer selects the first button, verifying a capability of the viewer's web browser using a verifying script and a verifying applet. The first presentation viewing webpage includes the verifying script and the verifying applet. The method further includes, if the viewer's web browser's capability is verified, prompting the viewer with a second button selectable for the viewer to activate the sharing of the viewer's screen images. The method further includes, upon the viewer selects the second button, requesting the server for a presenter token containing information of a first live sharing webpage including a sharing applet. The method further includes, loading the first live sharing webpage into the viewer's web browser based on the presenter token.

In some aspects, a method includes repeatedly verifying, with a server, whether the presenter holds a privilege to use a first live sharing webpage to share screen images of the presenter. The first live sharing webpage is loaded into a web browser of the presenter and includes a sharing applet that causes the server to relay the presenter's screen images from the presenter, through the server, to a viewer. The method further includes, if the presenter does not hold the privilege, receiving a link that, upon activated by the presenter, loads a first presentation viewing webpage into the presenter's web browser. The first presentation viewing webpage includes a first view area that allows the server to display screen images of the viewer.

In some other aspects, a system for switching control with browser-based screen sharing is disclosed. The system includes a processor, and a memory coupled to the processor. The memory stores a plurality of instructions which, when executed by the processor, cause the processor to load a first presentation viewing webpage into a web browser of a viewer. The first presentation viewing webpage includes a first view area that allows the server to display screen images of a presenter from the presenter, through the server, to the viewer. The instructions also cause the processor to deliver to the viewer, in the first presentation viewing webpage, a button selectable for the viewer to share screen images of the viewer to the presenter. The instructions also cause the processor to, upon the viewer selects the button, selectively enable the viewer to share the viewer's screen images with the presenter. The instructions also cause the processor to cause a second presentation viewing webpage to load into a browser of the presenter. The second presentation viewing webpage includes a second view area that allows the server to display the viewer's screen images.

### BRIEF DESCRIPTION OF DRAWINGS

The present embodiments are illustrated by way of example and are not intended to be limited by the figures of the accompanying drawings. In the drawings:

FIG. 1A illustrates a diagram of an exemplary system within which the present embodiments may be implemented;

FIG. 1B illustrates an exemplary system where a viewer of the presenter's screen takes control to share the viewer's screen with the presenter and the other viewers;

FIG. 2 depicts a flowchart illustrating an example of actions performed from a viewer's perspective to share the viewer's screen with the presenter and other viewers;

FIG. 3 illustrates a flowchart illustrating an example of actions performed from a presenter's perspective to view a viewer's screen;

FIG. 4 illustrates a button in an exemplary screenshot of the presenter's screen that can be selected by the presenter to allow any of the viewers to share their screens;

FIG. 5A illustrates a “Share My Screen” button in an exemplary screenshot of the viewer's screen that may appear if the presenter allows viewers to share their screens;

FIG. 5B illustrates a status window shown to the viewer after the viewer selects the “Share My Screen” button of FIG. 5A while an verifying applet checks the viewer's browser for java compatibility;

FIG. 6 illustrates an exemplary screenshot of the viewer's screen confirming that the user's browser meets the java requirements for sharing the screen; and

FIG. 7 illustrates an exemplary screenshot of the viewer's screen requesting that the user download an executable screen share application to enable the viewer to share his or her screen.

The same reference numbers and any acronyms identify elements or acts with the same or similar structure or functionality throughout the drawings and specification for ease of understanding and convenience.

### DETAILED DESCRIPTION

Techniques are disclosed for switching control with browser-based screen sharing. An exemplary method comprises sending a first presentation viewing webpage to a web browser of a viewer, the first presentation viewing webpage including a first view area that allows the server to display screen images of a presenter from the presenter, through the server, to the viewer; delivering to the viewer, in the first presentation viewing webpage, a button selectable for the viewer to share screen images Of the viewer to the presenter; upon the viewer selects the button, selectively enabling the viewer to share the viewer's screen images with the presenter; and causing a second presentation viewing webpage to load into a browser Of the presenter, wherein the second presentation viewing webpage includes a second view area that allows the server to display the viewer's screen images. Among other benefits, some embodiments provided herein enable control switching capabilities for a presenter and one or more viewers to switch roles during a browser-based screen sharing session regardless of whether one or more plugins (e.g., a Java plugin) are installed with the viewers' browsers.

Various examples of the present disclosure will now be described. The following description provides specific details for a thorough understanding and enabling description of these examples. One skilled in the relevant art will understand, however, that the embodiments disclosed herein may be practiced without many of these details. Likewise, one skilled in the relevant art will also understand that the present embodiments may include many other obvious features not described in detail herein. Additionally, some well-known methods, procedures, structures or functions may not be shown or described in detail below, so as to avoid unnecessarily obscuring the relevant description.

The techniques disclosed below is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

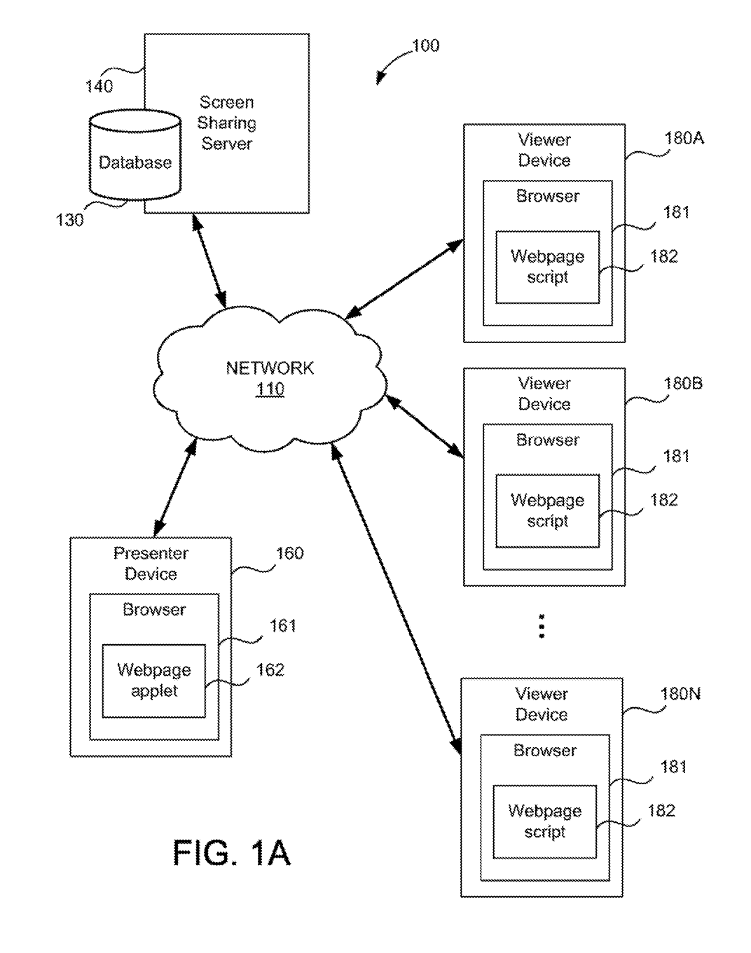

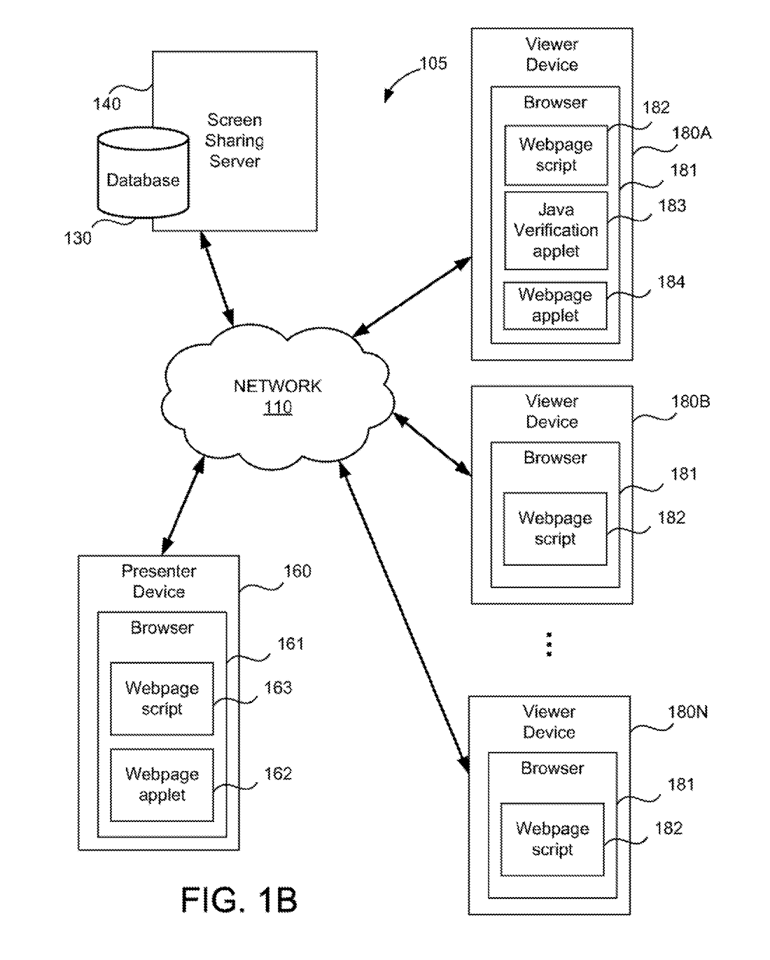

FIG. 1 A illustrates a diagram of an exemplary system 100 within which the present embodiments may be implemented. The system 100 includes a presenter operating a presenter device 160, one or more viewers operating viewer devices 180A-180N, a screen sharing server 140, and a network 110.

The viewer devices 180 and presenter device 160 can be any system and/or device, and/or any combination of devices/systems that is able to establish a connection, including wired, wireless, cellular connections with another device, a server and/or other systems such as screen sharing server 140. Viewer devices 180 and presenter device 160 typically include a display and/or other output functionalities to present information and data exchanged between or among the devices 180, 160 and/or the screen sharing server 140. In one embodiment, there is only a single screen sharing server 140. In one embodiment, there are multiple screen sharing servers 140 operating independently.

The viewer devices 180 and the presenter device 160 may include mobile, hand held, or portable devices, or non-portable devices and may be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g., an iPad, a Galaxy, Xoom Tablet, etc.), a tablet PC, a thin-client, a hand held console, a hand held gaming device or console, an iPhone, and/or any Other portable, mobile, hand held devices, etc. In one example, the viewer devices 180, screen sharing server 140, and presenter's device 160 are coupled via the network 110. In some other examples, the viewer devices 180, the presenter device 160, and screen sharing server 140 may be directly connected to one another.

The presenter device 160 and the viewer devices 180 should each be capable of running a web browser 161, 181. The viewer device web browser 181 is used by the viewer operating viewer device 180 to access a uniform resource locator (URL) to view a series of images of a shared screen of the presenter's device 160. The presenter device web browser 161 is used by the presenter to access a webpage with an embedded applet that permits remote control of the presenter's screen.

The input mechanism on viewer devices 180 and presenter device 160 can include, but is not limited to, a touch screen keypad (including single touch, multi-touch, gesture sensing in 2D or 3D, etc.), a physical keypad, a keyboard, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

The system 100 supports screen sharing of a presenter's screen on the presenter device 160 via the network 110 and the screen sharing server 140 to one or more viewers operating viewer devices 180A-180N, regardless of whether one or more typically required plugins (e.g., a Java plugin) are installed with viewers' browsers 181. U.S. patent application Ser. No. 12/953,054, entitled “METHOD AND SYSTEM FOR BROWSER-BASED SCREEN SHARING”, filed Nov. 23, 2010, assigned to the present assignee, describes a method and system of permitting a presenter to share his screen with one or more viewers while the presenter is actively using the screen, e.g., moving the cursor, typing text, and opening a window, and is incorporated herein by reference in its entirety.

The system 100 also supports detection of inputs from the one or more viewers, regardless of whether one or more typically required plugins (e.g., a Java plugin) are installed with the viewers' browsers 181. U.S. patent application Ser. No. 13/484,253, filed May 30, 2012, entitled “METHOD AND SYSTEM FOR BROWSER-BASED CONTROL OF A REMOTE COMPUTER”, assigned to the present assignee, provides a method and a system allowing one or more viewers, each using only a web browser, to interact with the image of the shared presenter's screen through the screen sharing server 140, and is also incorporated herein by reference in its entirety.

Generally, the presenter starts by providing to viewers a viewer URL that uniquely identifies the presenter. When a viewer goes to the viewer URL using a web browser, thereby loading a presentation viewing webpage, the viewer automatically sees a presentation slide or other content, such as images, selected by the presenter.

A particular presentation slide that may be selected by the presenter is a “live demo” slide, which loads a live sharing webpage containing a sharing applet or an embedded applet 162 (e.g., a Java applet) in a web browser 161 running on the presenter device 160. Upon receiving permission from the presenter (e.g., via a browser's security request to run Java applets), the applet 162 shares the presenter's screen with viewers who access the provided viewer IJRL without the viewer having to download any software or plug-ins. As the presenter moves the cursor on his screen, enters text, or interacts with the information displayed on the presenter's screen, the presenter's interactions are reflected on the viewer's monitors.

The webpage corresponding to the viewer URL provided by the presenter (i.e., the presentation viewing webpage) also contains an embedded script 182 (e.g., a Javascript and/or a series of AJAX code) that detects input or control events made by the viewer's input mechanism, such as mouse movements, clicks, mouse wheel rotations, or keyboard strokes, and sends the control events to the server 140. In addition, the applet 162 that is embedded in the live sharing webpage checks the server 140 for new viewer control events, executes them on the presenter's computer, and transmit images of the presenter's updated screen back to the viewer via the server 140.

The embodiments disclosed herein recognize that, during a live presentation (e.g., via the live demo slide) of an interactive sales pitch or a technical support session, it may also be beneficial to enable a viewer to share his or her screen to the presenter as well as to the other viewers. More specifically, in many instances, it is Often useful to allow viewers to share their screens instead of viewing the presenter's screen during the above-said screen sharing session, so that the original presenter can, for example, provide technical assistance to or further explain a detail on what is only visible on the remote, viewer's computer. The embodiments disclosed herein also recognize that, because the viewers may not share their screens on a frequent basis, the viewers typically do not have those required software or plugins installed, thereby causing delay, difficulty, and frustration.

Accordingly, some embodiments provided herein enable control switching capabilities for a presenter and one or more viewers to switch roles during a browser-based screen sharing session regardless of whether one or more plugins (e.g., a Java plugin) are installed with the viewers' browsers.

FIG. 1B illustrates an exemplary system 105 where a viewer (e.g., Of device 180A) of the presenter's screen takes control to share the viewer's screen with the presenter (e.g., of device 160) and other viewers (e.g., of devices 180B-180N), regardless of what plugins are installed with the viewer's browser 181 or on the viewer's computer device 180A. The system 105 includes the same devices as the system 100, including the presenter device 160, the viewer devices 180A-180N, the screen sharing server 140, and the network 110, only that at least some of them are configured differently.

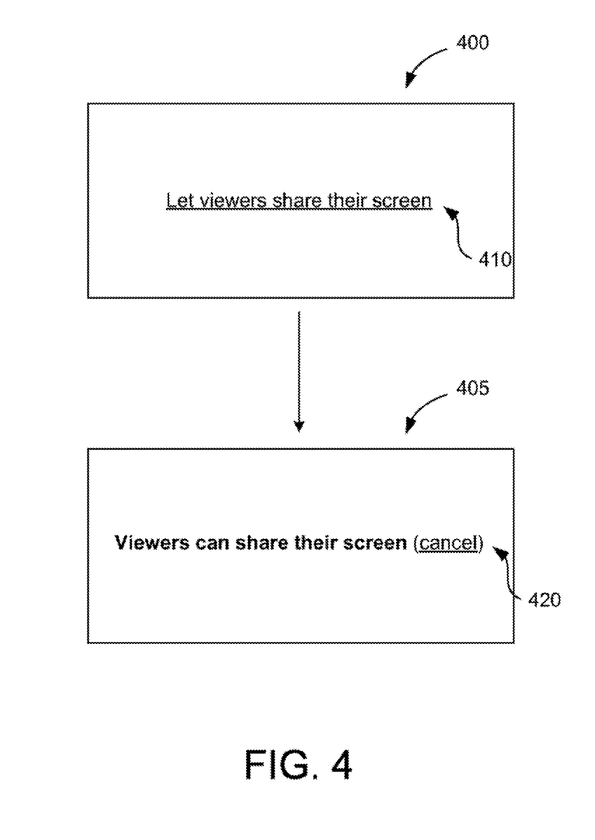

For purposes of facilitating a better understanding of the present embodiments, various functions and configurations of system 105 are now described in conjunction with FIGS. 4-7.

More specifically in system 105, as an alternative or an addition to the system 100, the presenter may allow the viewer to share the viewer's screen using a user interface element. In one embodiment, the presenter may explicitly select a link, such as link 410 that is shown on screenshot 400 Of FIG. 4, provided by applet 162, to give a permission that allows the viewer to share the viewer's screen images. In another embodiment, this function may be set by default so that it is automatically turned on whenever the presenter starts sharing his or her screen via the live sharing webpage. Once the presenter gives the permission for the viewer to share screen images (e.g., via clicking the link 410, FIG. 4, and the selection is detected by applet 162 and sent to the server 1 40), the presenter may also revoke this permission at any time, for example, by selecting a cancel link 420 that is shown on screenshot 405 Of FIG. 4 by applet 162 and the selection of which is also detected by applet 162 and sent to the server 140.

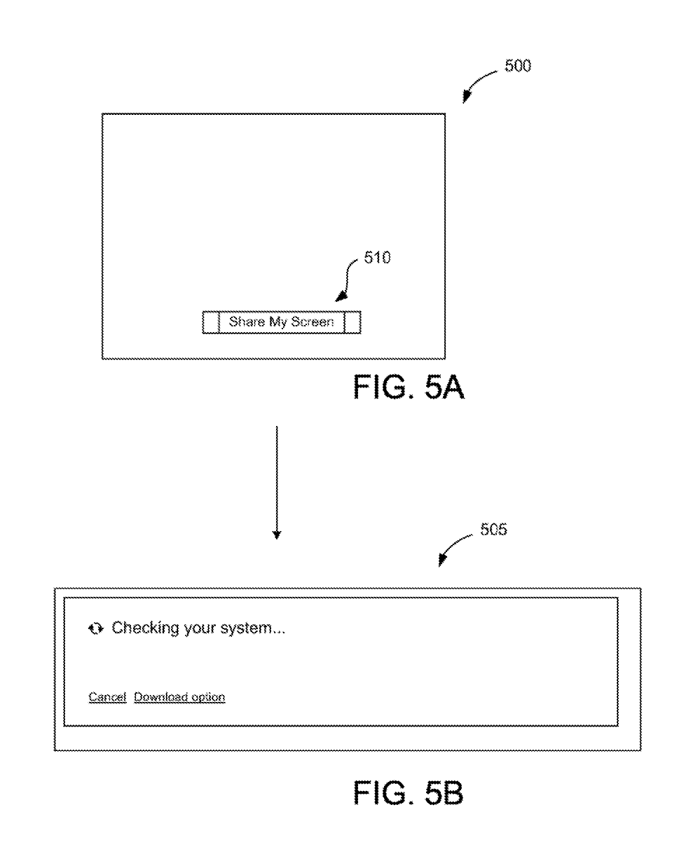

After the presenter gives the permission, any one of the viewers can now choose to share his or her screen. In some alternative embodiments, only a selected viewer may choose to share. A “Share My Screen” (SMS) button, such as button 510 shown on screenshot 500 Of FIG. 5A, is then delivered from the server 140 to be displayed by script 182 on each viewer's screen (e.g., in the presentation viewing webpage). The SMS button 510 is selectable for the viewer to initiate sharing of screen images of the viewer to the presenter and, optionally, with other viewers. The presentation viewing webpage may also include a detecting script (e.g., which may be included in script 182) that detects the viewer's selection of the button 510. In some embodiments, the server 140 may track a timeout for the viewer to select the SMS button 510. For example, if the timeout exceeds a predetermined amount of time before the viewer selects the button 510, then the server 140 may relinquish the button 510 by sending an relinquishing instruction to the viewer.

Upon the viewer selects the button 510, the server 140 selectively enables the viewer to share the viewer's screen images with the presenter based on a result of a verification of the browser 181's capability. More specifically, when the viewer clicks the SMS button 510, a verifying script (e.g., which may be included in script 182) that is embedded within the viewer's presentation viewing webpage starts a process to determine which method is available for sharing the viewer's screen images.

According to one embodiment, the verifying script triggers the viewer's web browser 181 then runs a “java verification” or a verifying applet 183 on the viewer's device 180A. The verifying applet 183 may determine if one or more required software (e.g., Java) is installed and whether the installed version of the required software meets at least the minimum acceptable standards for running the verifying applet 183 and/or for running a sharing applet that is similar to applet 162 Of FIG. 1A. The verifying applet 183 continues the process if this requirement is met. Together, the verifying script and the verifying applet 183 perform the verification, such as shown on screenshot 505 Of FIG. 5B.

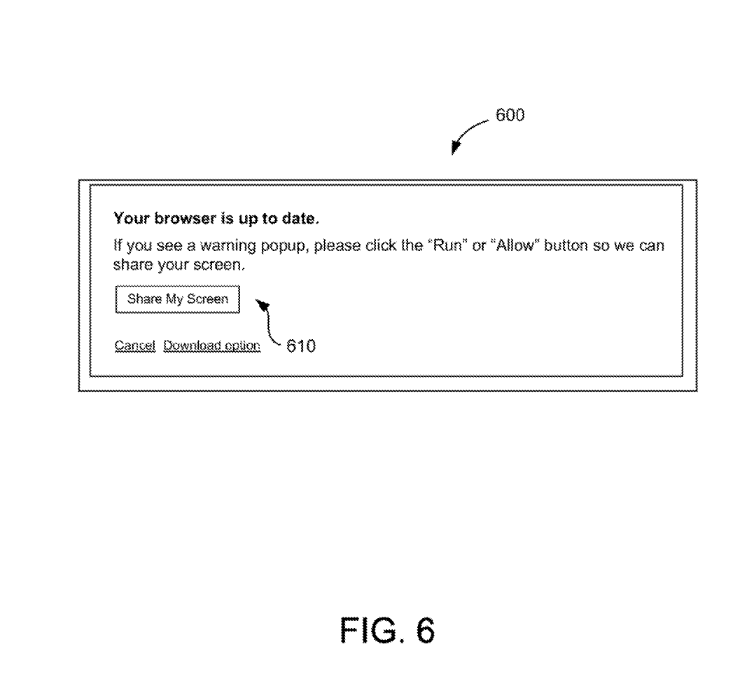

In one embodiment, if the requirement is met, that is, if the viewer's web browser 181's capability is verified, then the verifying applet 183 prompts the viewer with another button, such as button 610 shown on screenshot 600 of FIG. 6, that is selectable for the viewer to activate the Sharing Of the viewer's screen images to the presenter device 160 and other viewer devices 180B-180N. The verifying applet 183 may also display a message similar to screenshot 600 to notify the viewer that web browser 181's capability is verified. Depending on the embodiments, either the verifying applet 183 or the detecting script (e.g., which may be included in script 182), or other suitable means of detection may be used to detect selection of the button 610 by the viewer.

Upon the viewer selects the button 610, the verifying applet 183 sends a request for a presenter token to the server 140. The presenter token may contain information that instructs the viewer's web browser 181 to load a new live sharing webpage. When web browser 181 receives the presenter token, script 182 automatically redirects or loads the new live sharing webpage into the viewer's browser 181. The live sharing webpage includes a sharing applet 184, which in turn causes the server 140 to relay the viewer's screen images from the viewer (of device 180A) to the presenter (of device 160) and Other viewers (devices 180B-180N), in a manner similar to sharing applet 162 described in U.S. patent application Ser. No. 12/953,054.

In an alternative embodiment, if the viewer's web browser 181's capability is verified, then the applet 183 directly sends a request for a presenter token to the server 140. After the server 140 acknowledges the request, the server 140 transmits to the viewer the presenter token. Script 182 may need to regularly check with the server 140 for acknowledgement and for the presenter token. Upon receipt of the acknowledgement and the presenter token, the verifying applet 183 and/or the script 182 then prompts the viewer with button 610 for the viewer to activate the sharing of the viewer's screen. Upon the viewer selects the button 610, script 182 loads the live sharing webpage with the sharing applet 184.

It is noted that, in some embodiments, the presenter security token may altogether be omitted, and the server 140 may directly transmit relevant information (e.g., an URL to the live sharing webpage) to the viewer so as to cause the viewer's web browser 181 to load the live sharing webpage. For example, if the browser 181 is capable of executing the minimum required version of java software, the verifying script displays a confirmation message and the button 610 that, upon selection, immediately shares the viewer's screen by loading the live sharing webpage.

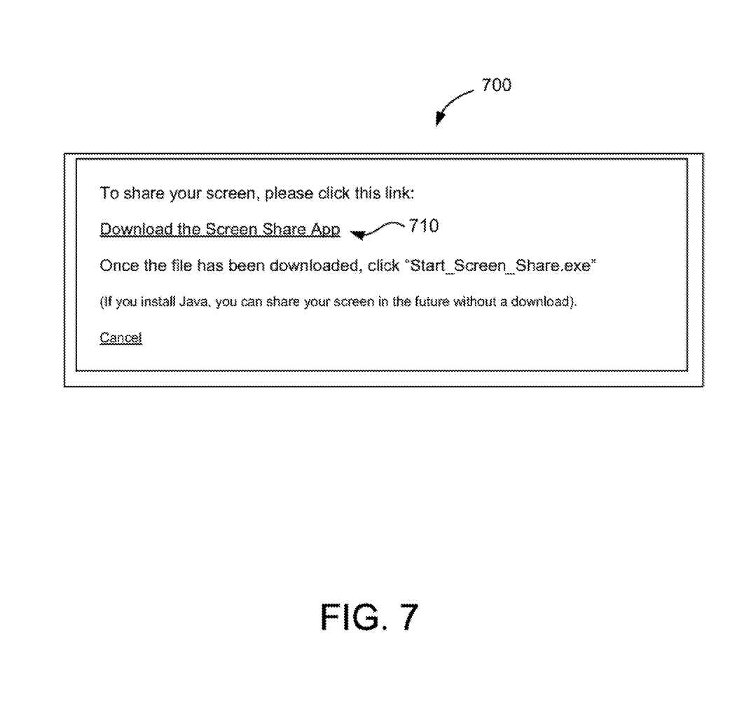

In accordance with embodiments disclosed herein, if the viewer's web browser 181's capability is not verified (e.g., if the acknowledgement and/or the presenter token is not received from the server 140 after a predetermined amount of time), the script 182 prompts the viewer with a link, such as link 710 shown on screenshot 700 of FIG. 7, to download an executable file from the server 140 or another location in the network 110. The executable file, upon being executed by the viewer, facilitates the viewer in sharing the viewer's screen images via the executable file, through server 140, to the presenter and other viewers. The executable file may load a new sharing applet to perform the functions of sharing applet 184, or the executable file may itself perform similar functions as the sharing applet 184.

After the screen sharing has passed from the presenter to the viewer, the server 140 informs the applet 162 (which is embedded in the presenter's original live sharing web page) of the presenter's device 160, and causes the applet 162 to redirect the browser 161 to load a new URL so that the original presenter's and the original viewer's roles are switched.

Notably, if the original presenter (e.g., of device 160) wishes to become a presenter again, the same techniques as described above may be followed. The new presenter (e.g., Of device 180A) may again allow Other viewers (of devices 180B-180N), including the original presenter, to share their screens using the aforementioned techniques. Nonetheless, in one or more embodiments, the server 140 may give higher priority to the original presenter above all the viewers when the presenter and one or more of the viewers choose to share their screen images at the same time. More specifically, the original presenter is given priority over other viewers to share his screen, so that if both the original presenter and another viewer clicks on their respective SMS buttons, the original presenter's screen gets selected to be shared. In one or more embodiments, the server 140 is configured to allow only one presenter at any given time; however, depending on the embodiments, the server 140 may employ different policies to allow more than one presenter at one time.

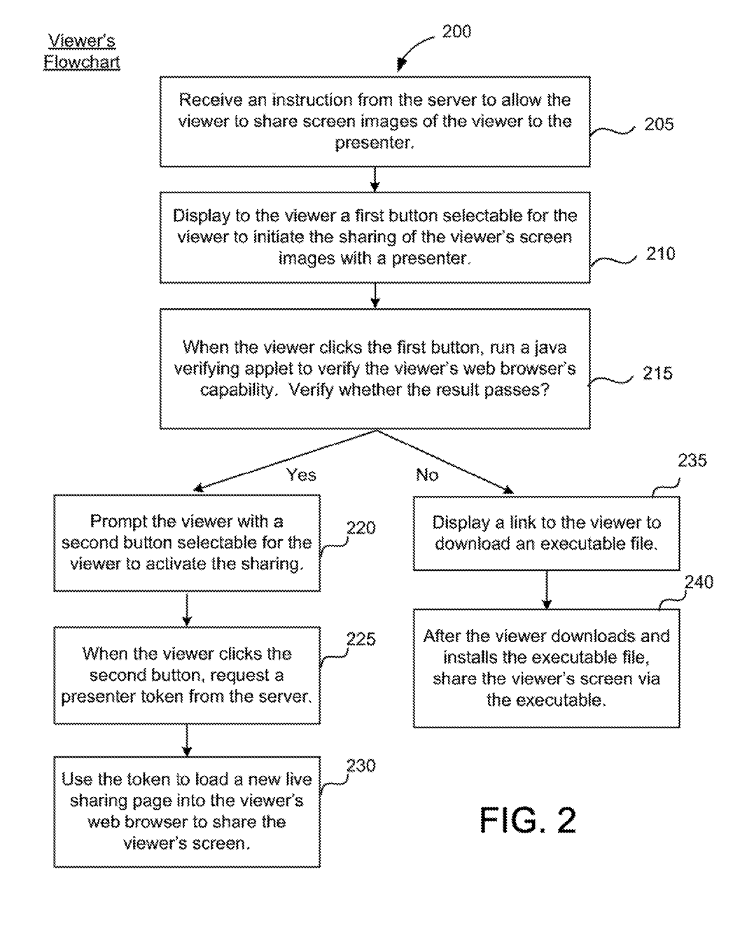

FIG. 2 depicts a flowchart illustrating an exemplary method 200 which, upon being implemented by instructions, may be downloaded and performed on a viewer's device to share the viewer's screen with the presenter and other viewers.

First, with reference to FIGS. 1B and 5A-7, a first presentation viewing webpage is loaded into a web browser (e.g., browser 181, FIG. 1B) of a viewer device (e.g., device 180A). The first presentation viewing webpage includes a first view area that allows a screen sharing server (e.g., server 140) to display screen images of the presenter from a presenter device (e.g., device 160), through the server 140, to the viewer device 180A. Next, the viewer device 180A receives (205) an instruction from the screen sharing server 140 to allow the viewer to share screen images of the viewer to the presenter. Upon receiving this instruction, the viewer device 180A displays (210) to the viewer a first button (e.g., button 510, FIG. 5A) selectable for the viewer to initiate the sharing of the viewer's screen images with the presenter device 160. Then, when the viewer clicks the first button 510, the viewer device 180A runs (215) a java verifying applet (e.g., applet 183, FIG. 1B) to verify a capability of the ‘viewer's web browser 181. In some embodiments, the first presentation viewing webpage loaded includes the verifying script and the verifying applet 183.

If the viewer's web browser 181's capability is verified (e.g., as shown on screenshot 600, FIG. 6), the viewer device 180A prompts (220) the viewer with a second button (e.g., button 610, FIG. 6) selectable for the viewer to activate the sharing. When the viewer clicks the second button 610, the viewer device 180A requests (225) a presenter token from the server 140. The presenter token contains information of a first live sharing webpage including a sharing applet (e.g., applet 184, FIG. 1B). Thereafter, the viewer device 180A uses (230) the token to load a new live sharing page into the viewer's web browser to share the viewer's screen.

However, if the viewer's web browser 181's capability is not verified (e.g., as shown on screenshot 700 Of FIG. 7), the viewer device 180A displays (235) a link (e.g., link 710, FIG. 7) to the viewer to download an executable file. The executable file, upon executed by the viewer, may facilitate the viewer in sharing the viewer's screen images via the executable file, through server 140, to the presenter. After the viewer downloads and installs the executable file, the viewer device 180A shares (240) the viewer's screen via the downloaded executable.

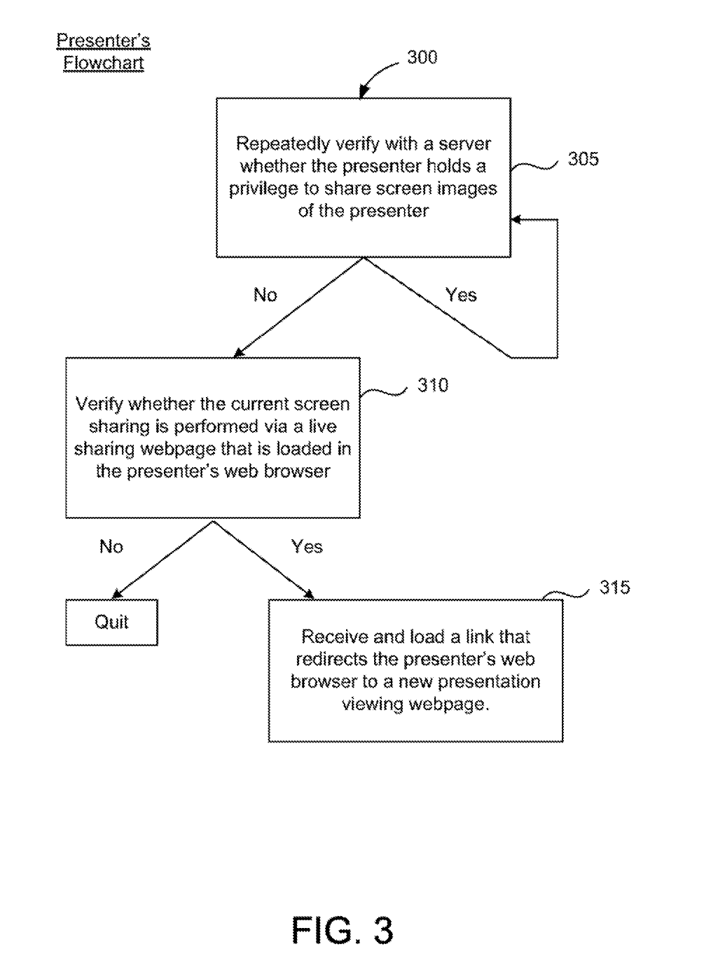

FIG. 3 depicts a flowchart illustrating an exemplary method 300 which, upon implemented by instructions, may be downloaded and performed on a presenter's device to view the viewer's screen.

First, with reference to FIGS. 1A, 1B and 4, a sharing applet (e.g., applet 162, FIG. 1B) is loaded onto a presenter device (e.g., device 160, FIG. 1B). Depending on the embodiment, the sharing applet 162 may be loaded via a live sharing webpage that is loaded on the presenter's browser (e.g., browser 161, FIG. 1B), or the sharing applet 162 may be loaded via an executable file that is downloaded and installed on the presenter device 160. The sharing applet 162 causes a screen sharing server (e.g., server 140, FIG. 1B) to relay the presenter's screen images from the presenter device 160, through the server 140, to a viewer device (e.g., device 180A, FIG. 1B). Upon running, the applet 162 on the presenter device 160 repeatedly verifies (305) with the server 140 whether the presenter holds a privilege to share screen images of the presenter to the viewer(s).

If it is determined that the presenter does not hold the privilege, the applet 162 verifies (310) whether the current screen sharing is performed via a live sharing webpage that is loaded in the presenter's web browser 161. If the applet 162 is not loaded in the live sharing webpage (e.g., if the applet 162 is loaded via the executable file), then the applet 162 quits from running on the presenter device 160, and the web browser automatically returns to a viewer URL, rather than displaying the presenter URL.

If applet 162 is loaded in the live sharing webpage, the applet 162 receives (315) and loads (315) a link from the server 140 that redirects the presenter's web browser 161 to a new presentation viewing webpage. The new presentation viewing webpage includes a viewing script (e.g., script 163) that shows a first view area which allows the server 140 to display screen images of a new presenter (e.g., the viewer operating the viewer device 180A).

In the foregoing specification, the examples have been described with reference to specific exemplary implementations thereof. It will, however, be evident that various modifications and changes may be made thereto without departing from the broader scope of the disclosure. The specification and drawings are, accordingly, to be regarded in an illustrative sense rather than a restrictive sense.

What is claimed is:

1. A system managing control within a browser-based screen sharing session between a presented and a viewer, the system comprising:
a first computer associated with the presenter comprising a first processor and a first display for displaying first screen images the presenter wishes to share with the viewer and connected to a global communications network;
a second computer associated with the viewer comprising a second processor and a second display for displaying the first screen images the presenter wishes to share with the viewer which have been acquired via the global communications network from the first computer; wherein
the viewer has loaded a first presentation viewing webpage into a first web browser in execution upon the second processor and displayed to the view on the second display which includes a first view area displaying the first screen images of a presenter from the presenter to the viewer;
the first presentation viewing webpage includes a first button selectable by the viewer allowing the viewer to share second screen images displayed upon the second display;
upon selection of the first button the second computer selective enables the second computer to share the second screen images with the presenter; by:
determining if a capability of the viewer's web browser allows for the second screen images of the viewer to be shared with the presenter;
upon a positive determination displaying to the viewer a second button selectable for the viewer to activate the synchronous sharing of the viewer's screen images;
upon determining selection of the second button a second presentation viewing webpage is loaded into a second web browser upon the first computer and the second screen images that the viewer wishes to share are viewed by the presented; and
the second processor tracks an idle timeout period such that the second processor transmits subsequent control events from the viewer to a screen sharing applet or another applet for execution on the first display when these subsequent control events are received within the idle timeout period otherwise the second processor relinquishes control and the screen sharing applet or another applet executes other control events generated by another viewer participating with the viewer and presenter.

2. The system according to claim 1, wherein
before the second processor selectively enables the viewer to share the second screen images the second processor verifies the capability of the first web browser; and
the verification employs a verifying script and a verifying applet that together perform the verification and form part of the first presentation viewing webpage.

3. The system according to claim 2, wherein
upon verification of the first web browser's capability a first live sharing webpage is loaded into the first web browser; and
the first live sharing webpage includes a sharing applet that causes the second computer to relay the second screen images from the viewer to the presenter.

4. The system according to claim 3, wherein
at least one of:
before the second processer loaded the first live sharing webpage a presenter token was transmitted to the second computer containing information that instructed the viewer's web browser to load the first live sharing webpage including the sharing applet; and
upon verification of the first web browser's capability a confirmation is displayed to the viewer upon the second display.

5. The system according to claim 2, wherein
upon failure to verify the first web browser's capability the viewer is prompted by a prompt displayed upon the second display to download an executable file which, upon executed by the viewer, facilitates the viewer in sharing the second screen images via the executable file to the presenter.

6. The system according to claim 1, wherein
displaying upon the second computer the first button to the viewer is determined in dependence upon whether a permission was received from the first computer triggered the presenter to allow the viewer to share the second screen images.

7. The system according to claim 1, wherein
first presentation viewing webpage includes a detecting script that detects the viewer's selection of the button.

8. The system according to claim 1, wherein
upon determining that the viewer is sharing the second screen images the system assigns a higher priority to actions relating to the presenter and the first screen images than the viewer and the second screen images.

9. The system according to claim 1, wherein
the second processor tracks a timeout for the viewer to select the first button, and
the second processor relinquishes the button if the timeout exceeds a predetermined amount of time.

10. The system according to claim 1, wherein
upon a negative determination with respect to the capability of the first web browser allowing the second screen images of the viewer to be shared with the presenter the viewer is prompted with a visual prompt upon the second display containing a link for the viewer to download an executable file, wherein the executable file, upon being executed by the viewer, facilitates the viewer in sharing the viewer's screen images via the executable file to the presenter and other viewers.

11. A system managing control within a browser-based screen sharing session between a presented and a viewer, the system comprising:
a first computer associated with the presenter comprising a first processor and a first display for displaying first screen images the presenter wishes to share with the viewer and connected to a global communications network;
a second computer associated with the viewer comprising a second processor and a second display for displaying the first screen images the presenter wishes to share with the viewer which have been acquired via the global communications network from the first computer; wherein
the viewer has loaded a first presentation viewing webpage into a first web browser in execution upon the second processor and displayed to the view on the second display which includes a first view area displaying the first screen images of a presenter from the presenter to the viewer;
the first presentation viewing webpage includes a first button selectable by the viewer allowing the viewer to share second screen images displayed upon the second display;
upon selection of the first button the second computer selective enables the second computer to
share the second screen images with the presenter; by:
determining if a capability of the viewer's web browser allows for the second screen images of the viewer to be shared with the presenter;
upon a positive determination displaying to the viewer a second button selectable for the viewer to activate the synchronous sharing of the viewer's screen images; and
upon determining selection of the second button a second presentation viewing webpage is loaded into a second web browser upon the first computer and the second screen images that the viewer wishes to share are viewed by the presented; and
the first screen images the presenter wishes to share are converted from presentation slides accessed by the presenter upon the first computer which can be viewed by either a synchronous session of viewing between the viewer and the presenter or an asynchronous session of viewing between the viewer and the presented, each of which is supported by a second presentation viewing webpage that enables either the synchronous session or the asynchronous session of presentation viewing between the presenter and the viewer via a placeholder presentation item among the presentation slides.

12. The system according to claim 11, wherein
before the second processor selectively enables the viewer to share the second screen images the second processor verifies the capability of the first web browser; and
the verification employs a verifying script and a verifying applet that together perform the verification and form part of the first presentation viewing webpage.

13. The system according to claim 12, wherein
upon verification of the first web browser's capability a first live sharing webpage is loaded into the first web browser; and
the first live sharing webpage includes a sharing applet that causes the second computer to relay the second screen images from the viewer to the presenter.

14. The system according to claim 13, wherein
at least one of:
before the second processer loaded the first live sharing webpage a presenter token was transmitted to the second computer containing information that instructed the viewer's web browser to load the first live sharing webpage including the sharing applet; and
upon verification of the first web browser's capability a confirmation is displayed to the viewer upon the second display.

15. The system according to claim 12, wherein
upon failure to verify the first web browser's capability the viewer is prompted by a prompt displayed upon the second display to download an executable file which, upon executed by the viewer, facilitates the viewer in sharing the second screen images via the executable file to the presenter.

16. The system according to claim 11, wherein
displaying upon the second computer the first button to the viewer is determined in dependence upon whether a permission was received from the first computer triggered the presenter to allow the viewer to share the second screen images.

17. The system according to claim 11, wherein
first presentation viewing webpage includes a detecting script that detects the viewer's selection of the button.

18. The system according to claim 11, wherein
upon determining that the viewer is sharing the second screen images the system assigns a higher priority to actions relating to the presenter and the first screen images than the viewer and the second screen images.

19. The system according to claim 11, wherein
the second processor tracks a timeout for the viewer to select the first button, and
the second processor relinquishes the button if the timeout exceeds a predetermined amount of time.

20. The system according to claim 1, wherein
upon a negative determination with respect to the capability of the first web browser allowing the second screen images of the viewer to be shared with the presenter the viewer is prompted with a visual prompt upon the second display containing a link for the viewer to download an executable file, wherein the executable file, upon being executed by the viewer, facilitates the viewer in sharing the viewer's screen images via the executable file to the presenter and other viewers.
